(19) United States
(12) Patent Application Publication
(10) Pub. No.: US 2009/0243577 A1
(43) Pub. Date: Oct. 1, 2009

(54) REVERSE CURRENT REDUCTION TECHNIQUE FOR DCDC SYSTEMS

(75) Inventor: Teik Kai LIM, Singapore (SG)

Correspondence Address: GREENBLUM & BERNSTEIN, P.L.C., 1950 ROLAND CLARKE PLACE, RESTON, VA, 20191, US

(73) Assignees: MATSUSHITA ELECTRIC INDUSTRIAL CO., LTD., Osaka (JP); PANASONIC SEMICONDUCTOR ASIA PTE., LTD., Singapore (SG)

(21) Appl. No.: 12/057,795

(22) Filed: Mar. 28, 2008

(51) Int. Cl. G05F 1/44; G05F 1/10

(52) U.S. Cl. 323/283; 323/282; 323/288

(57) ABSTRACT

The purpose of the present invention is to provide a method for switching devices that enables the prediction of when a reverse current condition will occur regardless of voltage-mode or current-mode switching regulator. According to the present invention, the reverse current reduction technique is realized by implementing a circuit which takes in the PWM signal, switching regulator's output signal and the Supply Voltage, before outputting a logic signal to indicate the start of reverse current flow; an OR gate, which outputs a logic signal to control the turning ON/OFF of the PMOS buffer at the output.

### BACKGROUND OF THE INVENTION

1. Field of Invention

Switching devices are now being used in almost everywhere around the globe. The main reasons cited are due to the low power consumed and the longer lifespan of such devices. Examples of switching devices are switching regulators and Class D power amplifiers.

2. Description of Related Art

A switching regulator can operate in 2 modes: 1) discontinuous conduction mode (DCM) and 2) continuous conduction mode (CCM). However, even though a switching regulator is designed to operate in CCM, it can go into DCM when load condition is small. The description of operation of both modes will be explained in subsequent paragraphs.

When designing switching regulator, most of the time synchronous switching is used. Synchronous switching uses 2 power switches (refer to FIGS. 1A and 1B) that can improve the efficiency. The 2 power switches in FIG. 1A are P1 and N1, whereas the 2 power switches in FIG. 1B are P2 and N2 respectively. Efficiency is a very important factor when dealing with portable devices where efficiency determines the battery life.

However, small load condition becomes a problem when synchronous switching regulator is used. Switching regulator always remains in CCM operation even though the load condition is small. Referring to FIGS. 2A, 2B and 2C, we notice that there is reverse current (negative current in the inductor) that flows back from output capacitor. As shown, this phenomenon occurs for both Buck and Boost modes. This reverse current or ‘always CCM’ operation can cause serious problems to a switching regulator, which will be described in the following paragraph.

One of the common problems associated with reverse currents is that the efficiency is badly affected during light load condition even though synchronous switching is used. Another problem is that the boost converter is not able to boost to very high output voltage when using ‘always CCM’ operation due to reverse current. For boost converter to achieve high output voltage, it is necessary to have very high duty cycle (during CCM). However, this increases the risk of going into instability (limitation of boost converter). Hence boost regulator is usually designed with non-synchronous switching that can operate in DCM to achieve high output voltage. As a result, efficiency cannot be high as non-synchronous switching is used.

To solve reverse current or always CCM operation issue when using synchronous switching regulator, reverse current detection is designed. Conventional method used is to design a comparator that detects reverse current (or 0V detection with small voltage offset). This is as shown in FIGS. 3A and 3B, for a buck and boost configurations respectively. Using FIG. 3B as reference, Reverse Current Detection comparator, RDET, is used to monitor the potential across the terminals of the PMOS transistor P2. Hence, essentially, the direction of flow of current across PMOS transistor P2 is monitored. When a reverse current condition occurs, the potential difference across PMOS transistor P2 is of the opposite polarity of the initial condition when the current is flowing in the forward direction towards the load. When such a condition happens, RDET will output a signal to turn off the PMOS transistor P2, hence stopping any further reverse current flow. The same principle applies for the operation of RDET used for the buck converter (as shown in FIG. 3A).

However the implementation of such a comparator to detect reverse current can be very difficult due to many reasons mentioned below.

Power NMOS transistor N1 (FIG. 3A) or Power PMOS transistor P2 (FIG. 3B) ON resistance cannot be too small because it is hard to detect small voltage across it. A small ON resistance would also mean that the reverse current need to be very large before there is any successful detection. However, deliberate increasing of the ON resistance of NMOS or PMOS for easy detection is not a wise move as it will affect efficiency (due to larger potential drop, and hence power loss, across the larger ON resistance).

Another alternative is to decrease the inductor size for easier detection so that ripple current amplitude is larger (rate of change in inductor current is faster). However larger current ripple means more current stress to power devices. Therefore size of power devices need to increase to handle the larger resultant peak current. This is also not a good method.

Another problem about this method is that the switching node has high voltage swing. It will generate too much noise to the input of the comparator. Sometimes it will create a wrong detection signal!

A high speed comparator is necessary especially for high switching frequency regulator. The ON time of the NMOS transistor N1 (FIG. 3A) or PMOS transistor P2 (FIG. 3B) can be so short until it is only ON for a few hundreds of nano-sec before any successful detection due to slow comparator.

For boost converter (FIG. 3B), output voltage is higher than input voltage. As such, detection comparator needs to have level shifter or protection circuit to protect against high voltage breakdown. Additions of such circuit will also slow down the speed of detection.

FIG. 4 is a diagram of a circuit for power supply control according to prior art US2006/0113980. The circuit comprise of a reverse current detection system that detects the number of times a reverse current condition has occurred. Once the pre-determined number of times of such detections has been reached, the circuit sends a signal to turn off the switching device (e.g. a switching regulator, a class D power amplifier, etc). Thus the reverse current condition is temporarily stopped. The problem with this method is that it allows the reverse current condition to happen, and only turns off the switching device after a pre-determined number of hits occur.

The present invention is intended to solve the problems mentioned above, and it is an object of the present invention to provide a protection for the circuit elements in a switching device, by predicting when a reverse current will occur, and hence turning off the NMOS in Buck converter design or PMOS in Boost converter design to prevent a reverse current from flowing into the circuit. The present invention can also apply to Buck-Boost converter.

### SUMMARY OF THE INVENTION

The purpose of this invention is to provide a method for switching devices that enables the prediction of when a reverse current condition will occur regardless of voltage-mode or current-mode switching regulator.

According to the present invention, the reverse current reduction technique is realized by implementing a circuit which takes in the PWM signal, switching regulator's output signal and the Supply Voltage, before outputting a logic signal to indicate the start of reverse current flow; an OR gate, which outputs a logic signal to control the turning ON/OFF of the PMOS buffer at the output.

For buck converter: a relationship made between the ON times of NMOS transistor N1 and PMOS transistor P1 may be easily obtained. Through this relationship, we will be able to know when the current flowing through the NMOS transistor N1 is expected to start flowing in the reverse direction.

For boost converter: a relationship made between the ON times of NMOS transistor N2 and PMOS transistor P2 may be easily obtained. Through this relationship, we will be able to know when the current flowing through the PMOS transistor P2 is expected to start flowing in the reverse direction.

The present invention does not occupy large mask area or involve complex design. And it can be applied to all sorts of switching regulator that uses synchronous switching and has the possibility of having reverse current.

### BRIEF DESCRIPTION OF THE DRAWINGS

FIG. 1A is a prior art drawing of a typical output stage of a synchronous buck converter configuration.

FIG. 1B is a prior art drawing of a typical output stage of a synchronous boost converter configuration.

FIG. 2A is a prior art drawing of a typical output stage of a synchronous buck converter configuration, showing the forward and reverse current directions.

FIG. 2B is a prior art drawing of a typical output stage of a synchronous boost converter configuration, showing the forward and reverse current directions.

FIG. 2C is a prior art drawing of a typical inductor current waveform under DCM operation, with reverse current shaded.

FIG. 3A is a prior art drawing of a typical output stage of a synchronous buck converter configuration, with a prior art implementation of a reverse current detection circuit.

FIG. 3B is a prior art drawing of a typical output stage of a synchronous boost converter configuration, with a prior art implementation of a reverse current detection circuit.

FIG. 4 is a prior art drawing of US20060113980 A1, implementing a reverse current detection system.

FIG. 5A is a block diagram showing a typical configuration of a Voltage Mode switching regulator.

FIG. 5B is yet another block diagram showing a typical configuration of a Current Mode switching regulator.

FIG. 6A shows a typical output stage of a synchronous boost converter, with a first preferred embodiment according to the present invention.

FIG. 6B shows a typical output stage of a synchronous boost converter, with a second preferred embodiment according to the present invention.

FIG. 6C shows a typical output stage of a synchronous boost converter, with a third preferred embodiment according to the present invention.

FIG. 7 shows waveforms of selected important nodes based on the present invention.

FIG. 8 shows waveforms of selected important nodes based on the present invention, when used under a CCM operation.

FIG. 9A shows a generic implementation of Timer for a synchronous boost converter based on the fourth preferred embodiment.

FIG. 9B shows one example of circuit implementation of Timer for a synchronous boost converter based on the fifth preferred embodiment.

FIG. 9C shows waveforms of selected important nodes based on the present invention.

FIG. 10A shows a typical output stage of a synchronous buck converter, with a sixth preferred embodiment according to the present invention.

FIG. 10B shows a typical output stage of a synchronous buck converter, with a seventh preferred embodiment according to the present invention.

FIG. 10C shows a typical output stage of a synchronous buck converter, with a eighth preferred embodiment according to the present invention.

FIG. 11 shows waveforms of selected important nodes based on the present invention.

FIG. 12 shows waveforms of selected important nodes based on the present invention, when used under a CCM operation.

FIG. 13A shows a generic implementation of Timer for a synchronous buck converter based on the ninth preferred embodiment

FIG. 13B shows one example of circuit implementation of Timer for a synchronous buck converter based on the tenth preferred embodiment.

FIG. 13C shows waveforms of selected important nodes based on the present invention.

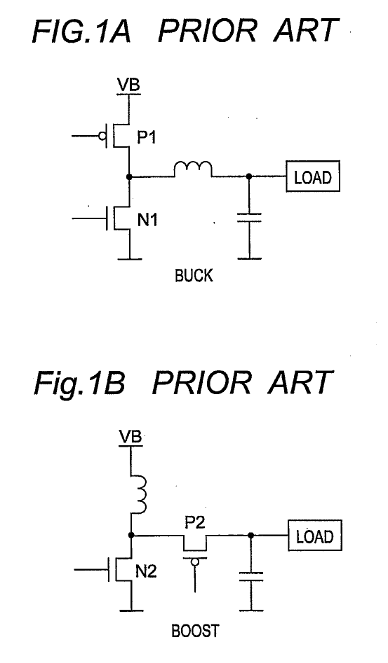

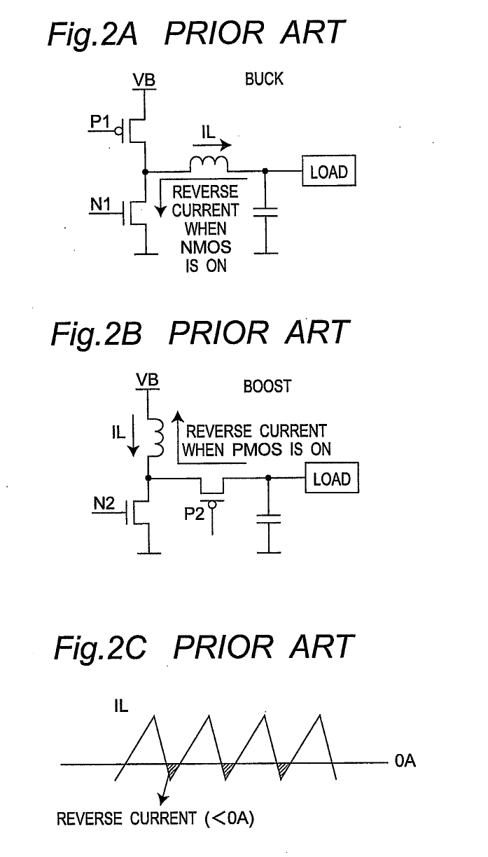

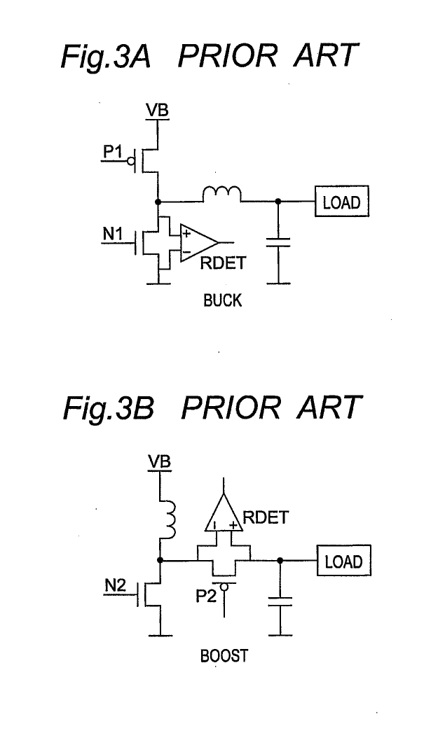

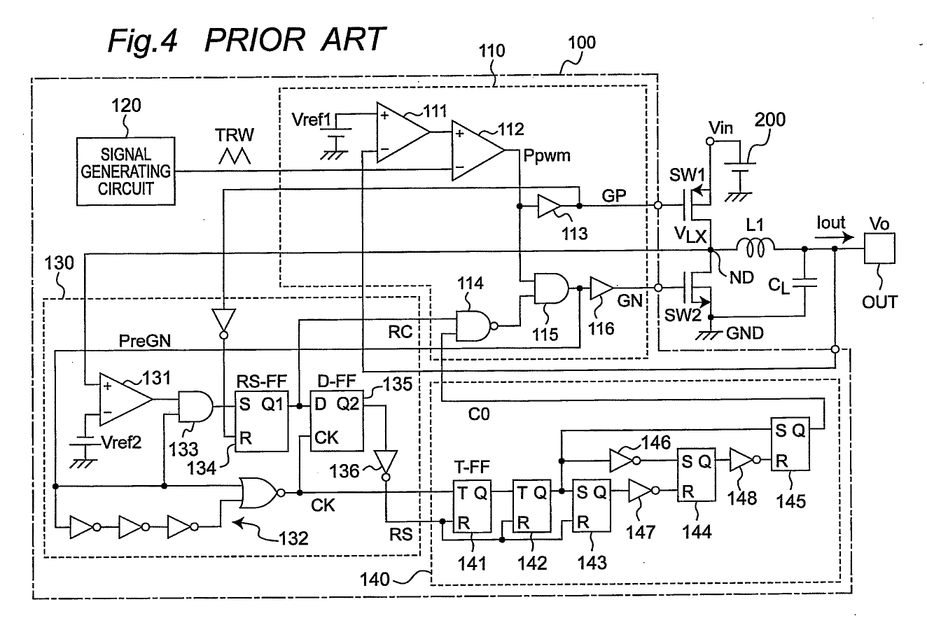

### DETAILED DESCRIPTION OF THE PREFERRED EMBODIMENTS

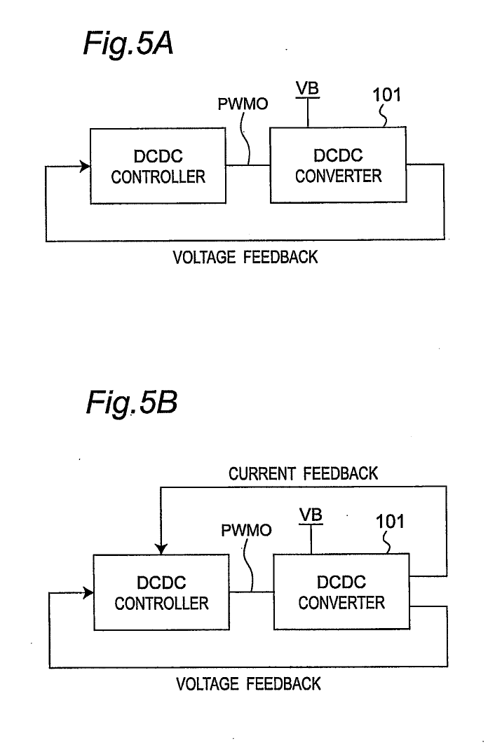

FIG. 5A is a block diagram showing a typical configuration of a Voltage Mode switching regulator, in which the present invention is typically used. FIG. 5B is yet another block diagram showing a typical configuration of a Current Mode switching regulator, in which the present invention may be alternatively be used. As shown in FIG. 5A, the DCDC Controller will generate PWM signal PWMO to determine how much time to turn ON and OFF the power transistors. The DCDC Converter block 101 shows an example of an implementation of the present invention, relative to the voltage mode switching regulator system.

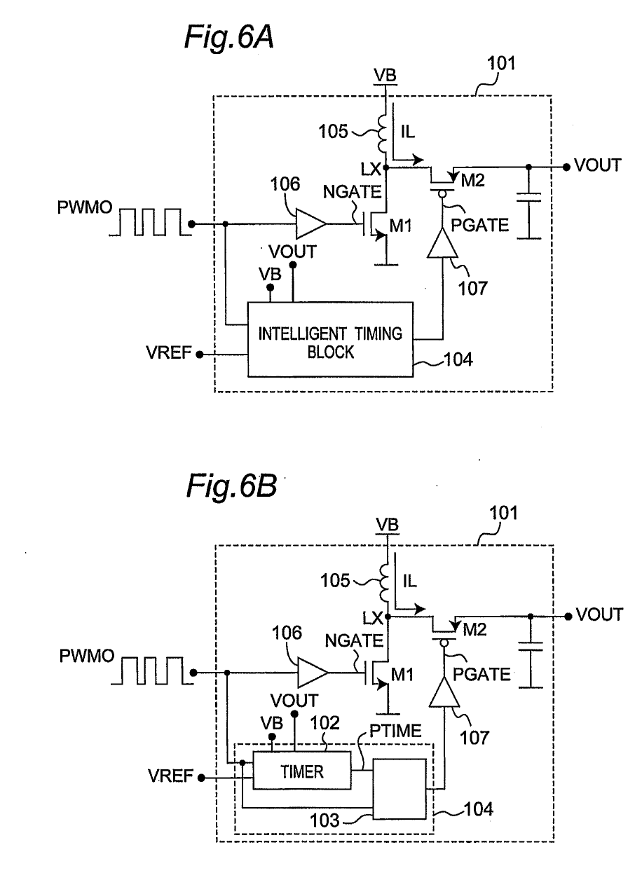

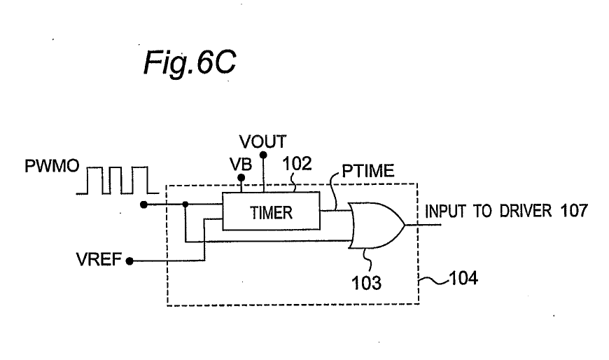

FIG. 6A shows a typical output stage of a synchronous boost converter, with a first preferred embodiment 104 according to the present invention, as implemented in the DCDC Converter block 101. We shall name the first preferred embodiment as the Intelligent Timing Block 104. Block 104 outputs a signal to the input of driver 107 so as to control the ON and OFF state of PMOS M2. Block 104 obtains as inputs: A VOUT signal or a switching node signal LX, a power supply voltage VB, and the PWM signal PWMO or any of its derivatives (e.g. inverted PWMO, delayed PWMO, etc). Block 104 will process the inputs and hence turn ON or OFF the PMOS M2 so as to prevent any reverse current from occurring. An exemplary operation of the first embodiment according to the present invention is explained as follows:

A case when PWM signal PWMO is high:

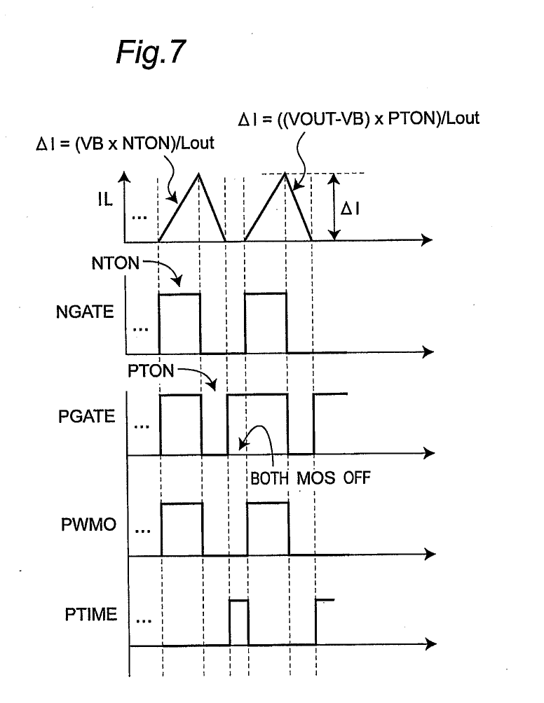

The following explanation makes reference to FIG. 6A and selected important waveforms in FIG. 7. The output signal of driver 106 will be equal to its input. Hence, the gate terminal of NMOS M1, NGATE, will be logic signal high. Thus, NMOS M1 is ON. The period when NMOS M1 is ON shall be referred to as period NTON. At the same time, Intelligent Timing Block 104 is configured so that the input of driver 107 is also high. The resultant high driver output will thus cause the gate terminal of PMOS M2, PGATE, to be high. Thus, PMOS M2 will be OFF. As a result, Inductor 105 will be charged up (current rising) during this time.

A case when PWM signal PWMO is low:

The following explanation makes reference to FIG. 6A and selected important waveforms as shown in FIG. 7. The output signal of driver 106 will be equal to its input. Hence, the gate terminal of NMOS M1 will be low. Thus, NMOS M1 is OFF. At the same time, Intelligent Timing Block 104 is configured so that the input of driver 107 is also low. The resultant low driver 107 output will thus cause the gate terminal of PMOS M2 to be low. Thus, PMOS M2 will be ON. The period when PMOS M2 is ON shall be referred to as period PTON. Inductor 105 will be discharged (current falling) during this time.

After a certain time (this timing will be further explained later), Block 104 will output a logic high. Thus, input of driver 107 being equal to its output, PGATE will thus be at a logic signal high. Thus, PMOS M2 is OFF. During this OFF time, both NMOS M1 and PMOS M2 are OFF. This state is known as dead-time. Any current left in inductor will be discharged through parasitic diode. PMOS M2 remains OFF until PWM signal PWMO goes high again to turn ON NMOS M1 again.

FIG. 6B shows a second preferred embodiment according the present invention. The present invention comprises of the following elements: a Timer 102 which determines the ON time of PMOS M2 and a logic block 103. Together, these 2 elements shall collectively comprise the Intelligent Timing Block 104. Next we shall explain the working of the second preferred embodiment according the present invention.

A case when PWM signal PWMO is high:

The following explanation makes reference to FIG. 6B and selected important waveforms as shown in FIG. 7. The output signal of driver 106 will be equal to its input. Hence, the gate terminal of NMOS M1 will be logic signal high. Thus, NMOS M1 is ON. The period when NMOS M1 is ON is equal to NTON. At the same time, Intelligent Timing Block 104 is configured so that the input of driver 107 is also high. The resultant high driver output will thus cause the gate terminal of PMOS M2 to be high. Thus, PMOS M2 will be OFF. As a result, Inductor 105 will be charged up (current rising) during this time.

A case when PWM signal PWMO is low:

The following explanation makes reference to FIG. 6B and selected important waveforms in FIG. 7. The output signal of driver 106 will be equal to its input. Hence, the gate terminal of NMOS M1 will be low. Thus, NMOS M1 is OFF. At the same time, Intelligent Timing Block 104 is configured so that the input of driver 107 is also low. The resultant low driver 107 output will thus cause the gate terminal of PMOS M2 to be low. Thus, PMOS M2 will be ON. The period when PMOS M2 is ON is equal to PTON. Inductor 105 will be discharged (current falling) during this time.

The default signal at node PTIME is logic signal low or a first unique signal S_{A}. The Timer 102 will give a logic signal high or a unique signal S_{B}, via node PTIME after a certain time (this timing will be further explained later). PTIME at logic signal high or upon receiving S_{B}, will cause the resultant output of logic block 103 to be high. Thus, input of driver 107 being equal to its output, PGATE will thus be at a logic signal high. Thus, PMOS M2 is OFF. During this OFF time, both NMOS M1 and PMOS M2 are OFF. This state is known as dead-time. Any current left in inductor will be discharged through parasitic diode. PMOS M2 remains OFF until PWM signal PWMO goes high again to turn ON NMOS M1 again.

FIG. 6C shows a third preferred embodiment according the present invention. Logic block 103 may be implemented using an OR gate.

Above is the case for DCM operation. Under the CCM operation, the invention does not cause any undesirable effects. The explanation is as follows:

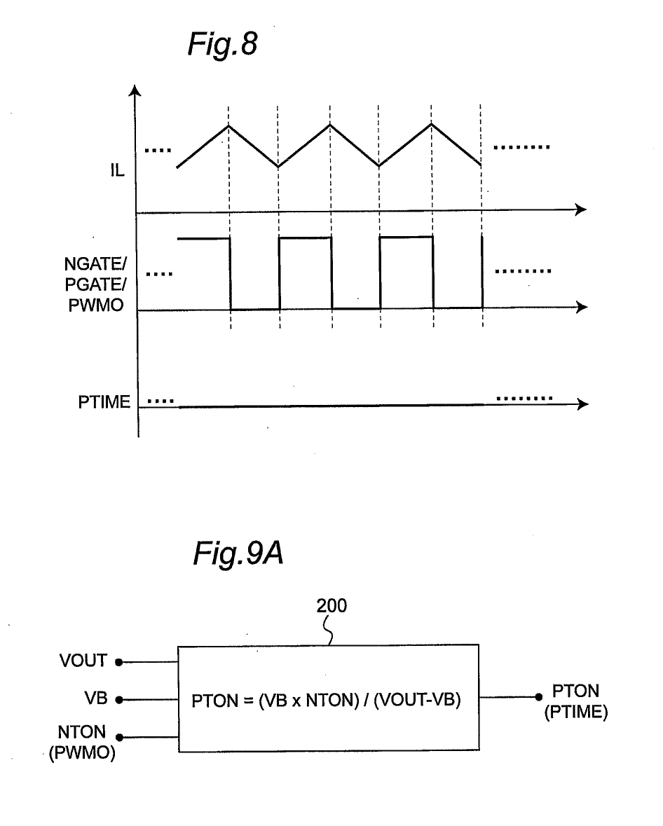

Referring to FIGS. 6B and 8, if NMOS M1 turns ON again before Timer 102 can give a logic signal high, there is no instance where both NMOS M1 and PMOS M2 are OFF (no dead-time). Moreover, reverse current does not occur for a CCM operation. This means that the Timer 102 will not give a logic signal high or a unique signal S_{B}, via node PTIME. Hence, the Intelligent Timing Block 104, according to the present invention, does not have any effect on the CCM operation.

An explanation of the time duration to determine the sequence of turning ON to OFF of PMOS M2 shall be given as follows:

Referring to FIG. 7, for a boost converter type of DCDC converter, current ripple across inductor is calculated based on NMOS and PMOS ON times as follows:

ΔI=((VB−LX)×NTON)/Lout(NMOSON) (1)

ΔI=((VOUT−LX−VB)×PTON)/Lout(PMOSON) (2)

where
NTON=time for which NMOS M1 is turned ON;
PTON=time for which PMOS M2 is turned ON;
ΔI=Inductor current rise/fall as a result of PWMO signal turning ON/OFF NMOS M1;
LX=switching node potential;
VB=power supply voltage;
VOUT=boost converter output voltage.

Equating together, we get:

(VB−LX)×NTON=(VOUT−LX−VB)×PTON (3)

Based on this relationship, with NTON (from PWM signal), VB and VOUT (input and output voltage sensing) known, we are able to turn OFF PMOS M2 once Timer 102 has reached PTON, where PTON is given by:

PTON=((VB−LX)×NTON)/(VOUT−LX−VB) (4)

Note that LX can be ignored if the voltage across M1 and M2 are significantly small.

Hence, for a case where the voltage across M1 and M2 are significantly small,

PTON=(VB×NTON)/(VOUT−VB)

The above case applies for cases where the delay times to turn ON and OFF of NMOS M1 and PMOS M2 are insignificant. For cases where delay times are significantly large, these delay times need to be considered in the timing estimation.

Case 1: Delay time to turn ON M1 is significantly larger than delay time to turn ON M2.

For this case, with the delay times known, just add the time difference to PTON. Hence, if delay time difference=T_{D1}, that means the formula shall now be:

PTON₁={(VB×NTON)/(VOUT−VB)}+T_{D1} (5)

Case 2: Delay time to turn ON M1 is significantly smaller than delay time to turn ON M2.

For this case, with the delay times known, just add the time difference to PTON. Hence, if delay time difference=T_{D2}, this means the formula shall now be:

PTON₁={(VB×NTON)/(VOUT−VB)}−T_{D2} (6)

The formulae (5) and (6) above are meant to give more accurate timing estimations. Nevertheless, even if there is difference in timing estimation from actual, parasitic diode will be activated to discharge any remaining charges in the inductor 105. Thus, depending on a case by case basis, the formulae need not be necessary to be implemented.

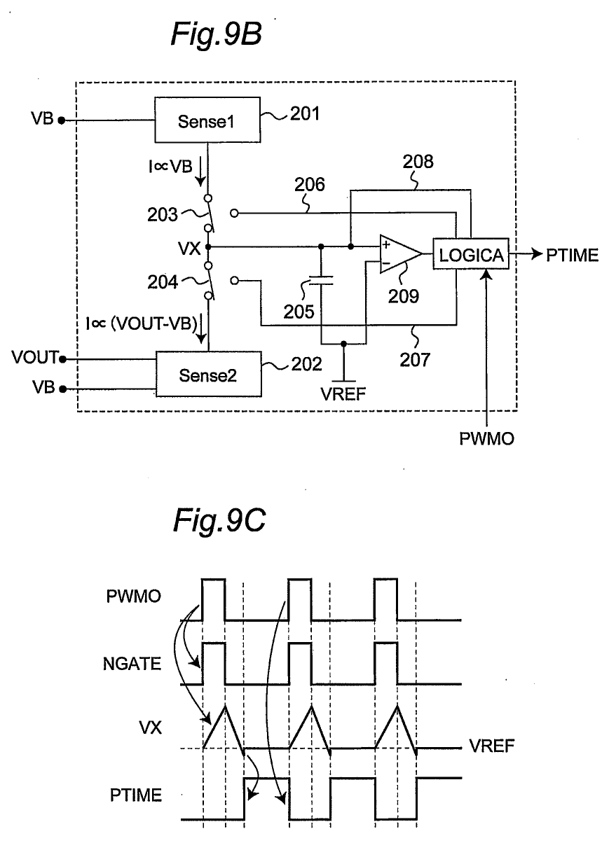

FIG. 9A shows a generic implementation 200 of the formula (4) based on the fourth preferred embodiment according to the present invention, whereby after a period of PTON defined by the above said formula, a signal PTIME is outputted to logic block 103.

FIG. 9B shows one example of circuit implementation of the generic implementation 200 of Timer 102 for a synchronous boost converter based on the fifth preferred embodiment according to the present invention. During NTON, LOGICA closes switch 203 via line 206 and capacitor 205 will be charged up from VREF by Sense1 block 201. Sense1 block is a typical V-I converter that sources a current proportional to VB. After NTON, LOGICA opens switch 203 via line 206 and closes switch 204 via line 207. Capacitor 205 will be discharged by Sense2 block 202. Sense2 block is a typical V-I converter that sinks a current proportional to (VOUT−VB). Once capacitor 205 has been discharged till VREF level, PTIME will go high or output a unique signal S_{B} to turn off the PMOS M2. LOGICA resets node VX to VREF via line 208, to ensure the voltage level at VX is equal to VREF.

Referring to FIG. 9C, the operation of the circuit implementation of FIG. 9B shall be explained:

When PWM signal, PWMO goes from low to high, correspondingly, NGATE goes to high, and node VX is charged up gradually from VREF by Sense1 block 201. After a period of NTON ends, the potential at node VX reduces due to discharge by Sense2 block 202. Once the node VX potential is reduced back to VREF, the comparator 209 will hence output a LOW signal, as an indication of its occurrence. Once LOGICA receives this LOW signal, LOGICA will output a PTIME high, causing both M1 and M2 to be off. At the next rising edge of PWMO, LOGICA causes PTIME to go back to logic signal LOW. The whole cycle then repeats.

As mentioned, the above relationships apply for the case of a boost converter type of DCDC converter. For other DCDC converter types, the same principle may be used, but the relationships differ.

We shall now describe the case for a synchronous buck converter.

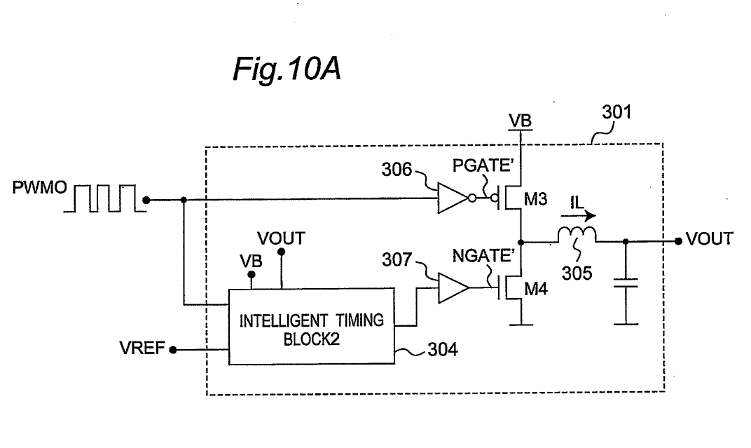

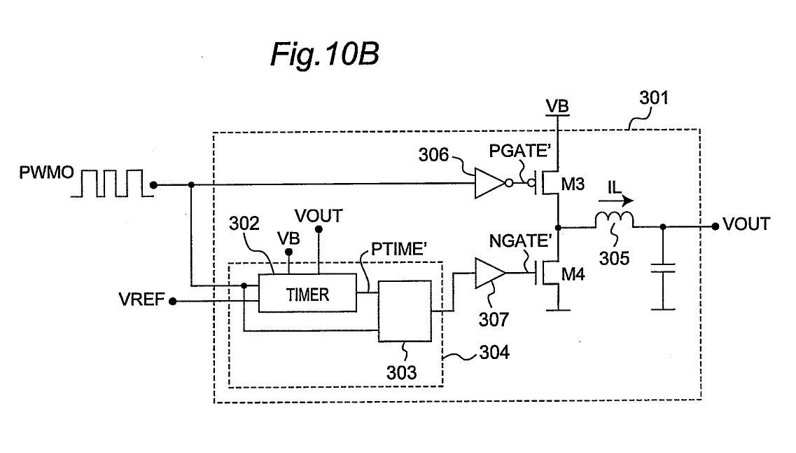

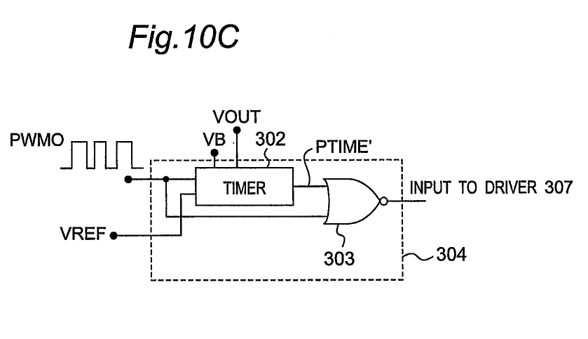

FIG. 10A shows a typical output stage of a synchronous buck converter, with a sixth preferred embodiment 304 according to the present invention, as implemented in the DCDC Converter block 301. We shall name the first preferred embodiment as the Intelligent Timing Block2 304. Block 304 outputs a signal to the input of driver 307 so as to control the ON and OFF state of NMOS M4. Block 304 obtains as inputs: A VOUT signal, a power supply voltage VB, and the PWM signal PWMO or any of its derivatives (e.g. inverted PWMO, delayed PWMO, etc). Block 304 will process the inputs and hence turn ON or OFF the NMOS M4 so as to prevent any reverse current from occurring. An exemplary operation of the sixth embodiment according to the present invention is explained as follows:

A case when PWM signal PWMO is high:

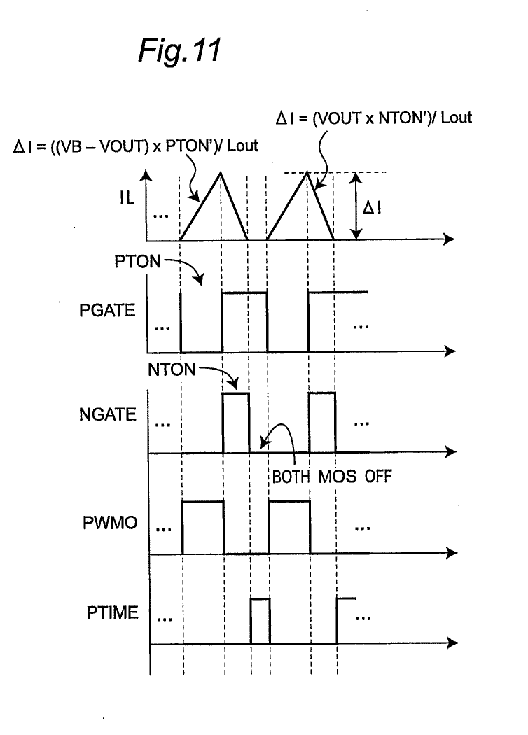

The following explanation makes reference to FIG. 10A and selected important waveforms in FIG. 11. The driver 306 is actually an inverter. Hence, the output signal of driver 306 will be an inversion of its input. Hence, the gate terminal of PMOS M3, PGATE′, will be logic signal low. Thus, PMOS M3 is ON. The period when PMOS M3 is ON shall be referred to as period PTON′. At the same time, Intelligent Timing Block2 304 is configured so that the input of driver 307 is low. The resultant low driver 307 output will thus cause the gate terminal of NMOS M4, NGATE′, to be low. Thus, NMOS M4 will be OFF. As a result, Inductor 305 will be charged up (current rising) during this time.

A case when PWM signal PWMO is low:

The following explanation makes reference to FIG. 10A and selected important waveforms as shown in FIG. 11. The output signal of driver 306 will be an inversion of its input. Hence, the gate terminal of PMOS M3 will be high. Thus, PMOS M3 is OFF. At the same time, Intelligent Timing Block2 304 is configured so that the input of driver 307 is also high. The resultant high driver 307 output will thus cause the gate terminal of NMOS M4 to be high. Thus, NMOS M4 will be ON. The period when NMOS M4 is ON shall be referred to as period NTON′. Inductor 305 will be discharged (current falling) during this time.

After a certain time (this timing will be further explained later), Block 304 will output a logic low. Thus, input of driver 307 being equal to its output, the gate of NMOS M4 will thus be at a logic signal low. Thus, NMOS M4 is OFF. During this OFF time, both PMOS M3 and NMOS M4 are OFF. This state is known as dead-time. Any current left in inductor will be discharged through parasitic diode. NMOS M4 remains OFF until PWM signal PWMO goes low again to turn ON PMOS M3 again.

FIG. 10B shows a seventh preferred embodiment according the present invention. The present invention comprises of the following elements: a Timer 302 which determines the ON time of NMOS M4 and a logic block 303. Together, these 2 elements shall collectively comprise the Intelligent Timing Block2 304. Next we shall explain the working of the seventh preferred embodiment according the present invention.

A case when PWM signal PWMO is high:

The following explanation makes reference to FIG. 10B and selected important waveforms as shown in FIG. 11. The output signal of driver 306 will be an inversion of its input. Hence, the gate terminal of PMOS M3 will be logic signal low. Thus, PMOS M3 is ON. The period when PMOS M3 is ON is equal to PTON′. At the same time, Intelligent Timing Block2 304 is configured so that the input of driver 307 is low. The resultant low driver output will thus cause the gate terminal of NMOS M4 to be low. Thus, NMOS M4 will be OFF. As a result, Inductor 305 will be charged up (current rising) during this time.

A case when PWM signal PWMO is low:

The following explanation makes reference to FIG. 10B and selected important waveforms in FIG. 11. The output signal of driver 306 will be an inversion of its input. Hence, the gate terminal of PMOS M3 will be high. Thus, PMOS M3 is OFF. At the same time, Intelligent Timing Block2 304 is configured so that the input of driver 307 is high. The resultant high driver 307 output will thus cause the gate terminal PGATE of NMOS M4 to be high. Thus, NMOS M4 will be ON. The period when NMOS M4 is ON is equal to NTON′. Inductor 305 will be discharged (current falling) during this time.

The default signal at node PTIME′ is logic signal low or a first unique signal S_{A}. The Timer 302 will give a logic signal high or a unique signal S_{B}, via node PTIME′ after a certain time (this timing will be further explained later). PTIME′ at logic signal high or upon receiving S_{A}, will cause the resultant output of logic block 303 to be low. Thus, input of driver 307 being equal to its output, PGATE will thus be at a logic signal low. Thus, NMOS M4 is OFF. During this OFF time, both PMOS M3 and NMOS M4 are OFF. This state is known as dead-time. Any current left in inductor will be discharged through parasitic diode. NMOS M4 remains OFF until PWM signal PWMO goes high again to turn ON PMOS M3 again.

FIG. 10C shows a eighth preferred embodiment according the present invention. Logic block 303 may be implemented using a NOR gate.

Above is the case for DCM operation. Under the CCM operation, the invention does not cause any undesirable effects. The explanation is as follows:

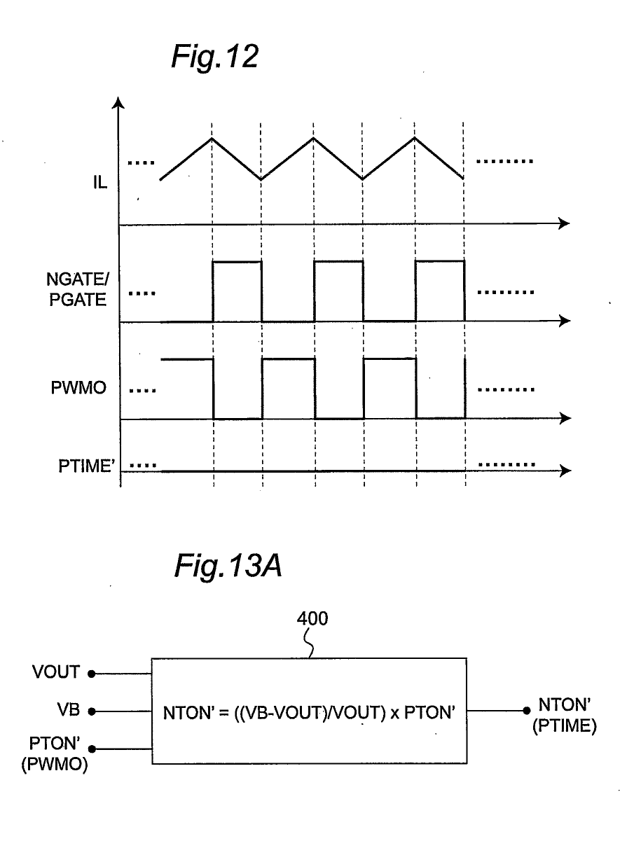

Referring to FIGS. 10B and 12, if PMOS M3 turns ON again before Timer 302 can give a logic signal high, there is no instance where both PMOS M3 and NMOS M4 are OFF (no dead-time). Moreover, reverse current does not occur for a CCM operation. This means that the Timer 302 will not give a logic signal high or a unique signal S_{B}, via node PTIME′. Hence, the Intelligent Timing Block2 304, according to the present invention, does not have any effect on the CCM operation.

An explanation of the time duration to determine the sequence of turning ON to OFF of NMOS M4 shall be given as follows:

Referring to FIG. 11, for a buck converter type of DCDC converter, current ripple across inductor is calculated based on NMOS and PMOS ON times as follows:

ΔI=((VB−LX−VOUT)×PTON′)/Lout(PMOSON) (7)

ΔI=((VOUT−LX)×NTON′)/Lout(NMOSON) (8)

Equating together, we get:

(VOUT−LX)×NTON′=(VB−LX−VOUT)×PTON′ (9)

where
NTON′=time for which NMOS M4 is turned ON;
PTON′=time for which PMOS M3 is turned ON;
ΔI=Inductor current rise/fall as a result of PWMO signal turning ON/OFF PMOS M3;
VB=power supply voltage;
VOUT=buck converter output voltage.

Based on this relationship, with PTON′ (from PWM signal), VB and VOUT (input and output voltage sensing) known, we are able to turn OFF NMOS M4 once Timer 302 has reached NTON′, where NTON′ is given by:

NTON′=((VB−LX−VOUT)/(VOUT−LX))×PTON′ (10)

Note that LX can be ignored if the voltage across M3 and M4 are significantly small.

Hence, for a case where the voltage across M3 and M4 are significantly small,

NTON′=((VB−VOUT)/VOUT)×PTON′

The above case applies for cases where the delay times to turn ON and OFF of PMOS M3 and NMOS M4 are insignificant. For cases where delay times are significantly large, these delay times need to be considered in the timing estimation.

Case 1: Delay time to turn ON M3 is significantly larger than delay time to turn ON M4.

For this case, with the delay times known, just add the time difference to NTON′. Hence, if delay time difference=T_{D3}, this means the formula shall now be:

NTON′=((VB−VOUT)/VOUT)×PTON′+T_{D3} (11)

Case 2: Delay time to turn ON M3 is significantly smaller than delay time to turn ON M4.

For this case, with the delay times known, just add the time difference to NTON′. Hence, if delay time difference=T_{D4}, this means the formula shall now be:

NTON′=((VB−VOUT)/VOUT)×PTON′−T_{D4} (12)

The formulae (11) and (12) above are meant to give more accurate timing estimations. Nevertheless, even if there is difference in timing estimation from actual, parasitic diode will be activated to discharge any remaining charges in the inductor 305. Thus, depending on a case by case basis, the formulae need not be necessary to be implemented.

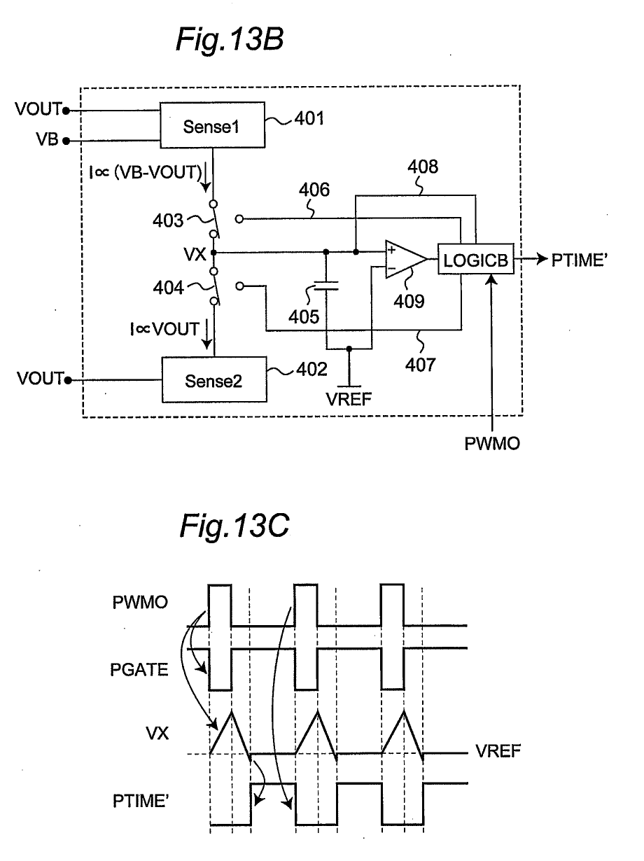

FIG. 13A shows a generic implementation 400 of the formula (10) based on the ninth preferred embodiment according to the present invention, whereby after a period of NTON′ defined by the above said formula, a signal PTIME′ is outputted to logic block 303.

FIG. 13B shows one example of circuit implementation of Timer 302 for a synchronous buck converter based on the tenth preferred embodiment according to the present invention. During PTON′, LOGICB closes switch 403 via line 406 and capacitor 405 will be charged up from VREF by Sense1 block 401. Sense1 block is a typical V-I converter that sources a current proportional to (VB−VOUT). After PTON′, LOGICB opens switch 403 via line 406 and closes switch 404 via line 407. Capacitor 405 will be discharged by Sense2 block 402. Sense2 block is a typical V-I converter that sinks a current proportional to (VOUT). Once capacitor 405 has been discharged till VREF level, PTIME′ will go high or output a unique signal S_{B} to turn off the NMOS M4. LOGICB resets node VX to VREF via line 408, to ensure the voltage level at VX is equal to VREF.

Referring to FIG. 13C, the operation of the circuit implementation of FIG. 13B shall be explained:

When PWM signal, PWMO goes from low to high, correspondingly, PGATE goes to low, and node VX is charged up gradually from VREF by Sense1 block 401. After a period of PTON′ ends, the potential at node VX reduces due to discharge by Sense2 block 402. Once the node VX potential is reduced back to VREF, the comparator 409 will hence output a LOW signal, as an indication of its occurrence. Once LOGICB receives this LOW signal, LOGICB will output a PTIME′ will go high, causing both M3 and M4 to be off. At the next rising edge of PWMO, LOGICB causes PTIME′ to go back to logic signal LOW. The whole cycle then repeats.

The above-described disclosure of the invention in terms of the presently preferred embodiments is not to be interpreted as intended for limiting. Various alterations and modifications will no doubt become apparent to those skilled in the art to which the invention pertains, after having read the disclosure. As a corollary to that, such alterations and modifications apparently fall within the true spirit and scope of the invention. Furthermore, it is to be understood that the appended claims be intended as covering the alterations and modifications.

What is claimed is:

1. A reverse current reduction apparatus within a switching regulator system comprising:
an inductor which is a typical element in a dcdc output stage;
a first transistor which, when turned on, charges the inductor;
a second transistor which, when turned on, discharges the inductor;
an intelligent timing block which outputs signals to control the turning on and off of the second transistor.

2. A reverse current reduction apparatus within a switching regulator system as described in claim 1, wherein said intelligent timing block comprises:
a timer block which determines the ON time of the said second transistor by issuing a unique signal to a first logic block;
a first logic block which receives the unique signal from the said timer block and hence causing the said second transistor to turn OFF or ON.

3. A reverse current reduction apparatus within a switching regulator system as described in claim 2, wherein said timer block comprises:
a first sensing arrangement coupled to an input supply voltage, operable to convert the said input supply voltage to a corresponding sourcing current via a sourcing terminal;
a second logic block arrangement coupled to the output of a monitoring arrangement, operable to output a signal to cause the said second to turn OFF and to control a first and second switches;
a first switch having 3 terminals, where the first terminal is coupled to the said sourcing terminal of the first sensing arrangement and the second terminal is coupled to a common node that connects together: an input terminal of a monitoring arrangement, a first terminal of a capacitor, a first output of a second logic block and a first terminal of a second switch. The third terminal is a control terminal that is coupled to the said second terminal of the said second logic block;
a second sensing arrangement coupled to the said input supply voltage and DCDC output voltage, operable to convert to a corresponding sinking current via a sinking terminal;
a second switch having 3 terminals, where the first terminal is coupled to a common node that connects together: an input terminal of a monitoring arrangement, a first terminal of a capacitor, a first output of a second logic block and a second terminal of the said first switch. The second terminal is coupled to the said sinking terminal of the said second sensing arrangement, and the third terminal is a control terminal that is coupled to a third terminal of the said second logic block;
a charge storage arrangement, coupled to the first and second said switches, operable to store the charge as a result of the sourcing current flow from the said first sense block;
a monitoring arrangement, coupled to a reference voltage and the said charge storage arrangement, operable to monitor the charge potential of the charge storage arrangement with respect to the said reference voltage and to output a unique signal to the said second logic block for instances of the potential at the said charge storage arrangement is higher or lower than the said reference voltage.

4. A reverse current reduction apparatus within a switching regulator system as described in claim 3, wherein said first and second sensing arrangement comprises a voltage to current converter.

5. A reverse current reduction apparatus within a switching regulator system as described in claim 3, wherein said charge storage arrangement comprises a capacitor.

6. A reverse current reduction apparatus within a switching regulator system as described in claim 3, wherein said monitoring arrangement comprises a comparator.

7. A reverse current reduction apparatus within a switching regulator system as described in claim 2, wherein said first logic block is a logic OR gate.

8. A method to reduce the reverse current that occurs in a switching regulator system, comprising:
charging up the output inductor in a typical dcdc output stage via a first transistor for a time period equal to the PWM signal input;
discharging the said inductor via a second transistor for a time period equal to the time period required to discharge the same amount of current initially charged via the said first transistor.
